(19) United States
(12) Patent Application Publication
(10) Pub. No.: US 2026/0330010 A1
(43) Pub. Date: Oct. 22, 2026

(54) USING POSITIVE AND NEGATIVE ARGUMENTS TO EVALUATE CYBERSECURITY ALERTS

(71) Applicant: International Business Machines Corporation, Armonk, NY (US)

(72) Inventors: Beat Buesser, Zurich (CH); Kathrin Grosse, Thalwil (CH); Mariam Hakobyan-Sobirov, Solothum (CH); Andreas Wespi, Niederhasli (CH)

(21) Appl. No.: 19/186,403

(22) Filed: Apr. 22, 2025

(51) Int. Cl. G06F 21/55

(52) U.S. Cl. CPC G06F 21/552; G06F 2221/034

(57) ABSTRACT

A method, according to one approach, includes: receiving a cybersecurity alert and generating first and second prompts associated with verifying the cybersecurity alert. The method includes causing a first trained AI based model to generate positive arguments to the first prompt. A second trained AI based model is used to generate negative arguments to the second prompt. Furthermore, a third trained AI based model is used to produce a final assessment of the cybersecurity alert based at least in part on the positive and negative arguments. In response to the final assessment indicating that the cybersecurity alert is not authentic, the cybersecurity based alert is rejected.

### BACKGROUND

The present invention relates to data storage systems, and more specifically, this invention relates to evaluating cybersecurity alerts in data storage systems.

The prevalence of computer systems has increased with the advancement of the Internet, and wireless network standards such as Bluetooth and Wi-Fi. Additionally, the adoption and development of smart devices, e.g., such as smartphones, televisions, tablets, and other devices in the Internet of Things (IoT) has increased as processing power and functionality improve.

Moreover, an increasing amount of physical material has been digitized. While this digital conversion improves data storage and data accessibility, it also increases the importance of maintaining cybersecurity (e.g., computer security). Cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

While some platforms have been developed to protect computer systems and networks from such attacks, threats are consistently evolving. Cybersecurity has also become a challenge due to the complexity of computer systems in general, as well as the broad application of computer networks. Computer systems and networks thereby face various types of attacks over time, and with them the number of alerts created by cybersecurity monitoring and analysis systems. Accordingly, there exists a need to develop an intelligent system that is able to automatically inspect cybersecurity related alerts and determine whether they are legitimate.

### SUMMARY

A method, according to one approach, includes: receiving a cybersecurity alert and generating first and second prompts associated with verifying the cybersecurity alert. The method includes causing a first trained AI based model to generate positive arguments to the first prompt. A second trained AI based model is used to generate negative arguments to the second prompt. Furthermore, a third trained AI based model is used to produce a final assessment of the cybersecurity alert based at least in part on the positive and negative arguments. In response to the final assessment indicating that the cybersecurity alert is not authentic, the cybersecurity based alert is rejected.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of sub-processes for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for improving the efficiency with which cybersecurity alerts are evaluated. For instance, approaches herein involve receiving cybersecurity alerts and determining whether they are valid alerts using AI based models (e.g., LLMs) that have been trained to perform different tasks that reveal different details or aspects of the received cybersecurity alerts. This desirably allows for malicious attempts at infiltrating a data storage location and/or system at large to be analyzed at an increased speed, thereby improving performance and security of the system as a whole, e.g., as will be described in further detail below.

In one general approach, a method includes: receiving a cybersecurity alert and generating at least first and second prompts associated with verifying the cybersecurity alert. The method includes causing a first trained AI based model to generate positive arguments to the prompt. A second trained AI based model is used to generate negative arguments to the prompt. Furthermore, a third trained AI based model is used to produce a final assessment of the cybersecurity alert based at least in part on the positive and negative arguments. In response to the final assessment indicating that the cybersecurity alert is not authentic, the cybersecurity based alert is rejected.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapped in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved alert inspection code at block 150 for improving the efficiency with which cybersecurity alerts are evaluated. For instance, approaches herein involve receiving cybersecurity alerts and determining whether they are valid alerts using AI based models (e.g., LLMs) that have been trained to perform different tasks that reveal different details or aspects of the received cybersecurity alerts. This desirably allows for malicious attempts at infiltrating a data storage location and/or system at large to be analyzed at an increased speed, thereby improving performance and security of the system as a whole, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

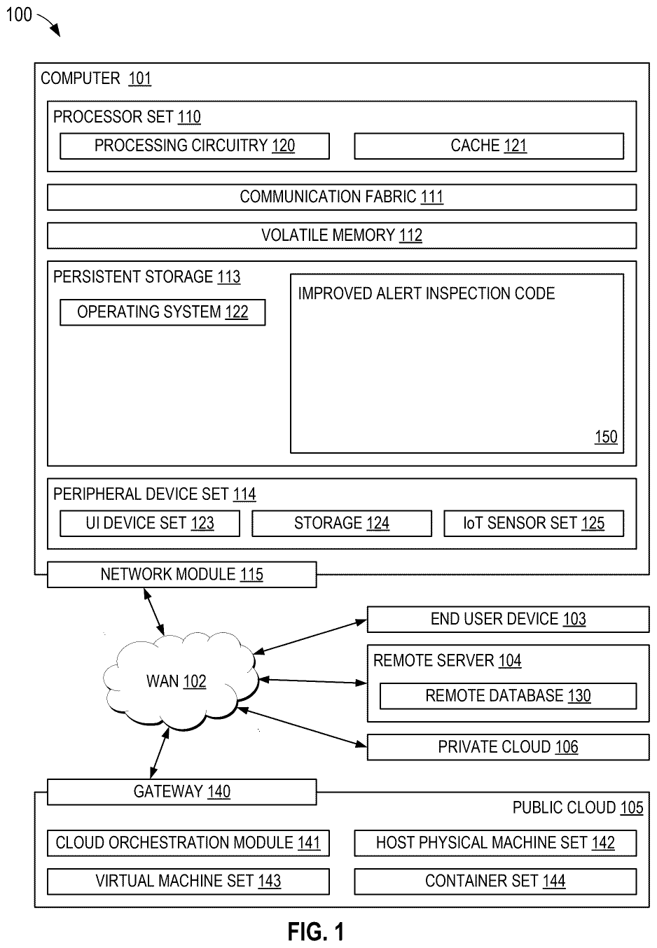

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, the prevalence of computer systems has increased with the advancement of the Internet, and wireless network standards such as Bluetooth and Wi-Fi. Additionally, the adoption and development of smart devices, e.g., such as smartphones, televisions, tablets, and other devices in the IoT has increased as processing power and functionality improve.

Further still, electronic source material has a number of benefits compared to physical documents. For example, electronic documents are easier to store and access in comparison to physical documents. While accessing a physical document involves manually searching each document in a collection until the desired document is found, multiple electronic documents can be automatically compared against one or more keywords. Moreover, electronic documents can be uploaded from and/or downloaded to any device connected to a network, while tangible documents (e.g., papers) must be physically transported between locations. Similarly, electronic documents take up much less space than their physical counterparts.

In view of these benefits, an increasing amount of physical material has been digitized. While this digital conversion improves data storage and data accessibility, it also increases the importance of maintaining cybersecurity (e.g., computer security). Again, cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

As the importance of computer systems and networks continues to increase, cybersecurity attacks pose an increasingly significant threat. Cybersecurity has thereby become a significant challenge due to the complexity of computer systems in general, as well as the broad application of computer networks. Cybersecurity attacks and threats have increased as a result, and with them the number of alerts created by cybersecurity monitoring and analysis systems. Conventional products have suffered from reduced performance stemming from the increased number of cybersecurity related threats. For instance, conventional implementations have relied on meticulously inspecting each received threat using security analysts. This causes increased latency and errors to be experienced, especially during periods of high threat. Accordingly, there exists a need to develop an intelligent system that is able to semi-automatically inspect cybersecurity related alerts and determine whether they are legitimate.

In sharp contrast to these conventional shortcomings, approaches herein are able to implement automation using machine learning models that are able to provide enough transparency as a result of automatically evaluating received cybersecurity alerts and determining their relative authenticity. Approaches herein are thereby able to combine the expertise of security analysts and AI based models that have been trained to provide information that is relevant in making a determination. This is achieved at least in part by training and implementing multiple AI based models that are configured to debate with each other in a transparent fashion, e.g., as will be described in further detail below.

It should also be noted that although various approaches herein are described in the context of receiving, evaluating, and determining whether cybersecurity related alerts are valid, any of the approaches herein may be implemented in different environments. For example, approaches herein may be utilized to evaluate security related alerts received from a physical system (e.g., security system for an office building), which is in no way intended to be limiting.

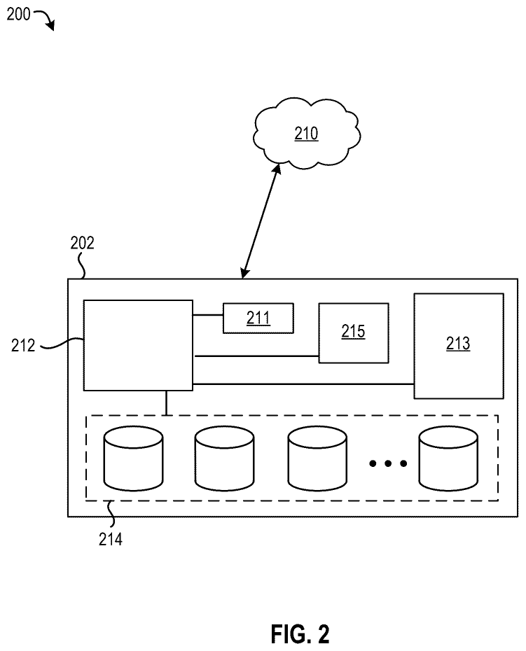

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central data storage location 202 that may be connected to any desired devices, systems, sub-systems, components, etc. over network 210. The central data storage location 202 may thereby be positioned at different geographical locations, in the same data center, or even in the same physical computing system as the other components, systems, devices, etc. that are connected thereto. For example, central data storage location 202 may be connected to computing environment 100 of FIG. 1 and/or any of the components therein.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, direct attached storage, an internal telephone network, etc. As a result, any desired information, data, commands, instructions, responses, requests, etc. may be sent between central data storage location 202 and any devices, systems, components, etc. that may be connected thereto, regardless of the amount of separation which exists therebetween, e.g., despite being positioned at different geographical locations. According to some approaches, the central data storage location 202 is a remote cloud server that is connected to (e.g., may be accessed by) user device(s) and/or edge node(s).

However, it should be noted that central data storage location 202 may be connected to other systems, devices, components, etc., differently depending on the approach. According to an example, which is in no way intended to limit the invention, two servers (e.g., nodes) may be located relatively close to each other and connected by a wired connection, e.g., a cable, a fiber-optic link, a wire, etc., or any other type of connection which would be apparent to one skilled in the art after reading the present description.

The terms “user,” and “administrator” are in no way intended to be limiting either. For instance, while users, and/or administrators may be described as being individuals in various implementations herein, a user, host, and/or administrator may be an application, an organization, a preset process, etc. The use of “data” and “information” herein are in no way intended to be limiting either, and may include any desired type of details, e.g., depending on the type of operating system implemented on the central data storage location 202. In some approaches, host write requests are received at the central data storage location 202 from a host (e.g., user and/or administrator) at a user device and/or an edge node that may be connected to the central data storage location 202 over network 210. Accordingly, data may be written to memory at the central data storage location 202 in response to receiving host write requests, e.g., as would be appreciated by one skilled in the art after reading the present description.

With continued reference to FIG. 2, the central data storage location 202 includes a large (e.g., robust) processor 212 that is coupled to a cache 211, an AI module 213, a data storage array 214 having a relatively high storage capacity, and a security operations center (SOC) module 215. It should be noted that while system 200 includes a SOC module 215, this is in no way intended to be limiting. For example, the SOC may be implemented as a much larger implementation, e.g., such as a standalone system and/or sub-system having various components that communicate with the central data storage location 202 and/or processor 212 therein.

The processor 212 and cache 211 are preferably configured to receive and process various requests, demands, instructions, commands, cybersecurity alerts, etc., involving data that may be stored in data storage array 214. Additionally, the AI module 213 and SOC module 215 may work together to inspect each of the received requests, demands, instructions, commands, cybersecurity alerts, etc., to determine their validity. In other words, the AI module 213 and SOC module 215 are preferably configured to identify nefarious attempts to infiltrate any component of the computing environment (e.g., such as computing environment 100 of FIG. 1), the central data storage location 202, and/or the system 200 at large. In some approaches, this may involve inspecting cybersecurity alerts that are received at the system, e.g., in response to a potentially malicious cybersecurity related attempt being made.

For instance, the SOC module 215 may desirably unify and coordinate cybersecurity technologies and operations that are associated with the system 200. As alluded to above, the SOC module 215 may work in combination with the AI module 213 to detect, analyze, and respond to received cybersecurity alerts close to real-time. As used herein, “cybersecurity alerts” refers to any kind(s) of security alerts that are related to a computing environment (e.g., such as computing environment 100 of FIG. 1). This orchestration of cybersecurity functions allows the SOC module 215 to maintain vigilance over the network 210 and/or any local networks at central data storage location 202 as well as any applications running therein and/or a computing environment (e.g., such as computing environment 100 of FIG. 1). The SOC module 215 may also continually analyze internal and external threat data to find ways to improve the overall security of the system 200 and/or any component of a computing environment (e.g., such as computing environment 100 of FIG. 1). Moreover, by combining the AI based evaluation with input received from security analysts, approaches herein are able to improve detection and prevention measures and security policies, perform faster threat detection, as well as more effective responses to security threats in terms of cost, time, and other aspects. The SOC module 215 can also improve customer confidence, simplify and strengthen compliance with industry standards, etc. This desirably ensures a proactive defense posture against cybersecurity based threats, e.g., as will be described in further detail below.

The data storage array 214 may include any desired type of data storage components depending on the approach. Thus, while the data storage array 214 may be illustrated as including hard disk drives, this is in no way intended to be limiting. In other approaches, the array 214 may include solid state drives having volatile and/or non-volatile memory therein, magnetic tape drives, optical storage drives, etc. For instance, the central data storage location 202 may have a data storage module (not shown) including an array of storage devices. The array of storage devices may further include non-volatile memory that is used to store data, e.g., as would be appreciated by one skilled in the art after reading the present description.

The AI module 213 may further include any desired number and/or type of AI based models, e.g., such as machine learning models, deep learning models, Large Language Models (LLMs), or foundation models. In preferred approaches, the AI module 213, processor 212, and/or the SOC module 215 are able to train one or more AI based models to inspect cybersecurity alerts and determine their validity. Accordingly, approaches herein are able to automate the procedure of analyzing and determining whether cybersecurity alerts are valid by making use of one or multiple LLMs in addition to utilizing analysts to guide the decision-making process.

According to an example, which is in no way intended to be limiting, a first LLM may be trained to identify arguments that support classifying a cybersecurity alert as a true positive, while a second LLM may be trained to identify arguments that support classifying a cybersecurity alert as a false positive. Accordingly, the first LLM is configured to generate positive arguments (e.g., affirmations) which support the legitimacy of cybersecurity alerts that are received, while the second LLM is configured to generate negative arguments (e.g., refutations) which deny the legitimacy of cybersecurity alerts that are received. Additionally, a third LLM may be trained (e.g., configured) to process both the positive and negative arguments to reach a final decision on whether a received cybersecurity alert is a true positive that needs to be acted on or not. In some approaches, a human cybersecurity analyst may further oversee and support the decision-making process. For instance, the cybersecurity analyst may select and evaluate the most relevant positive and negative arguments to consider, or he may even add his own positive or negative arguments, before making a determination as to whether a received cybersecurity alert is valid, e.g., as will be described in further detail below.

With continued reference to FIG. 2, the AI based models may be trained over time using characteristics (e.g., features) extracted from stored data in real-time and/or offline. However, one or more AI based models may be initially trained externally to the data storage location 202 (e.g., before being implemented therein) and AI module 213 may use characteristics gleaned from how incoming cybersecurity alerts are ultimately handled to re-train the AI based model(s) over time. For example, characteristics collected from newly received cybersecurity alerts may be inserted into one or more AI based model(s) to calculate a classification score that is used to determine whether ransomware and/or other types of cybersecurity attacks are present.

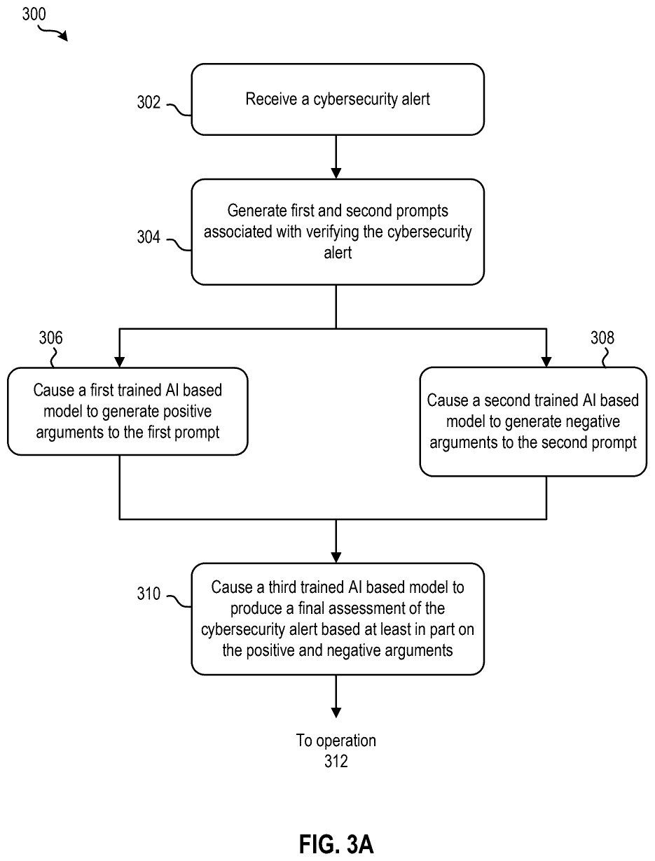

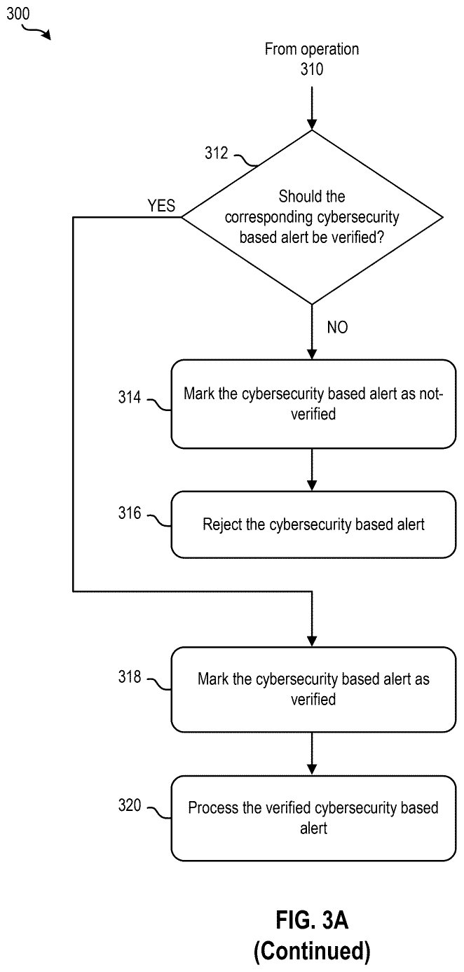

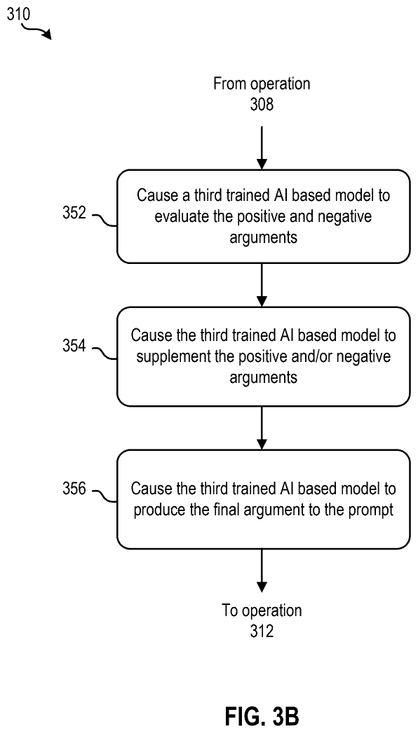

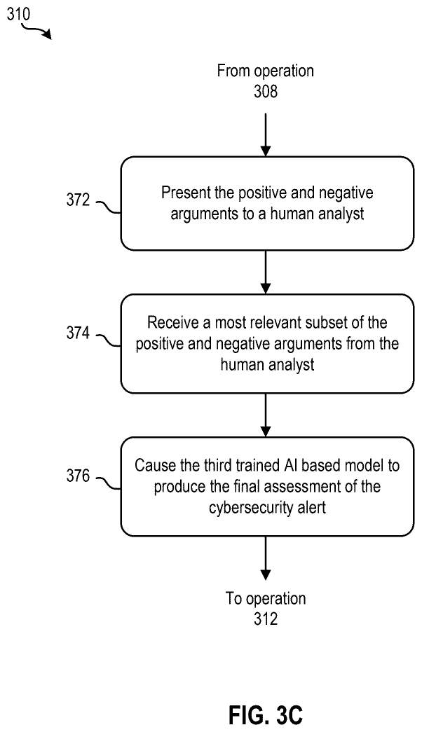

Now referring to FIG. 3A, a flowchart of a method 300 for improving the efficiency with which cybersecurity alerts are evaluated is illustrated in accordance with one approach. For instance, operations in method 300 involve receiving cybersecurity alerts and determining whether they are valid alerts using AI based models (e.g., LLMs) that have been trained to perform different tasks that reveal different details or aspects of the received cybersecurity alerts. As noted above, this allows for nefarious attempts at infiltrating a data storage location and/or system at large to be analyzed at an increased speed, e.g., as will be described in further detail below.

The method 300 may be performed in accordance with the present invention in any of the environments depicted in FIGS. 1-2, among others, in various approaches. For instance, one or more operations in method 300 may be performed by components in the central data storage location 202 of FIG. 2. Moreover, more or less operations than those specifically described in FIG. 3A may be included in method 300, as would be understood by one skilled in the art upon reading the present descriptions.

Each of the steps of the method 300 may be performed by any suitable component of the operating environment using known techniques and/or techniques that would become readily apparent to one skilled in the art upon reading the present disclosure. For example, in various implementations, the method 300 may be partially or entirely performed by a controller, a processor (e.g., see processor 212 of FIG. 2), one or more machine learning models (e.g., see machine learning module 213 of FIG. 2), a SOC (e.g., see SOC module 215 of FIG. 2), etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving a cybersecurity alert. Depending on the approach, the cybersecurity alert may be received from a locally running application, a remote system, one or more sensors, a user, etc. Moreover, the cybersecurity alert may be received at a SOC in some approaches. As noted above, a SOC is preferably able to unify and coordinate cybersecurity technologies and operations that are associated with a given system. For instance, a SOC may work in combination with an AI module to detect, analyze, and dynamically react to the cybersecurity alerts received in operation 302 in real-time. This orchestration of cybersecurity functions allows the SOC to maintain vigilance over system resources, e.g., such as networks as well as any applications running therein. The SOC may also continually analyze internal and external threat data to find ways to improve the overall security of the system. Moreover, by combining this AI based evaluation with input received from security analysts, approaches herein are desirably able to improve preventative measures and security policies, perform faster threat detection, as well as more effective responses to security threats in terms of cost, time, and other aspects. The SOC can also improve customer confidence, simplify and strengthen compliance with industry standards, etc. This desirably ensures a proactive defense posture against cybersecurity based threats. However, it should be noted that this is in no way intended to be limiting. Rather, incoming cybersecurity alerts may be received by a processor (e.g., see processor 212 of FIG. 2), a cache (e.g., see cache 211 of FIG. 2), an AI based module (e.g., see AI based module 213 of FIG. 2), etc.

In response to receiving at least one cybersecurity alert, method 300 advances from operation 302 to operation 304. There, operation 304 includes generating a prompt associated with verifying the cybersecurity alert. In other words, operation 304 includes creating at least first and second prompts that incorporate the cybersecurity alert received in operation 302. More specifically, operation 304 includes generating a positive prompt and a negative prompt. The positive prompt calls for information that may be used to support the legitimacy of the cybersecurity alert received in operation 302, while the negative prompt calls for information that may be used to refute the legitimacy of the cybersecurity alert received in operation 302. According to a non-limiting example, the positive prompt may include “provide arguments that support why this alert should be considered a TRUE alert”, while the negative prompt may state “provide arguments that support why this alert should be considered a FALSE alert.”

In some approaches, the first, second, and/or other prompts are generated using one or more AI based models that are configured to (e.g., have been trained to) evaluate cybersecurity alerts and generate prompts that can be used to determine whether the alerts are legitimate. As noted above, the prompts are preferably created such that they each pose a question that calls for information supporting whether the cybersecurity alert should be affirmed or denied. In some instances, the prompts may include justifications and/or statements that can either be confirmed (e.g., affirmed) or rejected (e.g., denied) depending on the situation. In some approaches, the prompts are made available (e.g., accessible) to analysts for evaluation. The prompts may be uploaded to a privately accessible location, uploaded to a publicly accessible location, sent directly to one or more AI based models, etc. Moreover, the prompts may be tuned over time, e.g., in response to real-time performance, past evaluations, industry standards, patterns identified by AI based models, etc. Tuned prompts may further be sent directly to the AI based models for evaluation in real-time.

From operation 304, method 300 advances to operations 306 and 308 in parallel. It follows that operations 306 and 308 may be performed at least partially simultaneously. There, operation 306 includes causing a first trained AI based model to generate positive arguments to the first prompt, while operation 308 includes causing a second trained AI based model to generate negative arguments to the second prompt. Looking first to operation 306, one or more instructions are sent to a first AI based model that causes the AI based model to generate positive arguments (also referred to herein as “responses”) that support the prompt formed in operation 304 and the cybersecurity alert received in operation 302. In some approaches, operation 306 involves causing the first trained AI based model to generate positive answers (e.g., “yes” answers) to prompts that include at least one question therein pertaining to the legitimacy of a received cybersecurity alert. In other words, the first AI based model may be trained to generate positive answers which support the legitimacy of prompts that include at least one question. Thus, positive arguments produced for a prompt that includes a question support a positive answer, and positive arguments produced for a prompt that includes a statement support the correctness of the statement.

In other approaches, operation 306 involves causing the first trained AI based model to generate positive arguments that support the legitimacy of received prompts that include at least one statement therein pertaining to the legitimacy of a received cybersecurity alert. In other words, the first AI based model may be trained to generate supporting characterizations of prompts that include at least one statement. In some approaches, the positive answers and arguments are generated to support the legitimacy of received prompts, while negative answers and arguments are generated to question the legitimacy of received prompts, e.g., as would be appreciated by one skilled in the art after reading the present description. Thus, negative arguments produced for a prompt that includes a question support a negative answer, and negative arguments produced for a prompt that includes a statement support the incorrectness of the statement.

As noted above, operation 308 includes causing a second trained AI based model to generate negative arguments to the prompt. In other words, a second AI based model (trained differently than the “first” AI based model mentioned above) is used to generate negative arguments (also referred to herein as “responses”) that oppose the legitimacy of the prompt formed in operation 304 and the cybersecurity alert received in operation 302. Additionally, operation 308 involves causing the second trained AI based model to generate negative answers (e.g., “no” answers and/or justifications thereof) to prompts that include at least one question therein pertaining to the legitimacy of a received cybersecurity alert. In other words, the second AI based model may be trained to generate negative answers which oppose the legitimacy of prompts that include at least one question. In other approaches, operation 308 involves causing the second trained AI based model to generate negative arguments that oppose the legitimacy of received prompts that include at least one statement therein pertaining to the legitimacy of a received cybersecurity alert. In other words, the second AI based model may be trained to generate negative characterizations of prompts that include at least one statement. In some approaches, AI based models may also output that arguments supporting why the cybersecurity alert should be considered a true alert cannot be located. Such a response may mean that there is no positive argument returned. In other cases, multiple arguments may be returned.

It should be noted that although two different AI based models are used to perform operation 306 and 308 in the present approach, different configurations may be implemented. For example, a single AI based model may be trained to provide positive and negative arguments (e.g., support) for a received cybersecurity alert. This single model may be a general purpose model that is trained to answer all kinds of security questions. In other situations, multiple different AI based models may be used to create positive arguments, and multiple different AI based models may be used to create negative arguments.

With continued reference to FIG. 3A, method 300 advances from operation 308 and proceeds to operation 310. There, operation 310 includes causing a third trained AI based model to produce a final assessment of the cybersecurity alert based at least in part on the positive and negative arguments. In other words, operation 310 includes sending one or more instructions to a third AI based model that has been trained to evaluate the positive and negative arguments produced by the first and second AI based models in operations 306, 308 respectively, to determine whether the cybersecurity alert should be approved or denied. For instance, the third AI based model may use information gathered from evaluating the arguments to make a determination as to whether the cybersecurity alert should be approved (indicating that the received cybersecurity alert is genuine and should be processed) or denied (indicating that the received cybersecurity alert is questionable and should be ignored). With respect to the present description, it should be noted that “final assessment” includes an answer to the question of whether the cybersecurity alert received in operation 302 has actually been verified. In other words, the final assessment includes a determination that indicates whether the identified cybersecurity alert is valid. The final assessment also preferably includes a justification which outlines (e.g., explains) how and/or why the particular answer was produced, e.g., as would be appreciated by one skilled in the art after reading the present description. As a simple example, if there are only positive arguments and no negative arguments, it can be concluded that the alert is a true positive and response is based on summarizing the positive arguments.

Referring momentarily now to FIG. 3B, exemplary sub-operations of evaluating the positive and negative arguments produced by the first and second AI based models (e.g., see operations 306, 308 respectively) to determine whether the corresponding cybersecurity alert should be verified, are illustrated in accordance with one approach. It follows that one or more of the sub-operations in FIG. 3B may be used to perform operation 310 of FIG. 3A periodically, e.g., in response to receiving one or more instructions, in response to a predetermined condition being met, in response to a cybersecurity alert and/or corresponding prompt, etc. However, it should be noted that the sub-operations of FIG. 3B are illustrated in accordance with one approach which is in no way intended to limit the invention. For instance, sub-operations of FIG. 3B are described in the context of evaluating a single prompt and corresponding cybersecurity alert, which is in no way intended to be limiting. Rather, any desired number of prompts and/or corresponding cybersecurity alerts may be evaluated and compared to determine relative similarity or patterns across the alerts, e.g., as would be appreciated by one skilled in the art after reading the present description.

As shown, sub-operation 352 includes causing a third trained AI based model to evaluate the positive and negative arguments, while optional sub-operation 354 includes causing the third trained AI based model to supplement the positive and/or negative arguments. In preferred approaches, the trained AI based model may be the same or similar models as the “third” AI based model as referred to herein. Accordingly, sub-operations 352 354 may implement an AI based model that has been trained to evaluate the positive and negative arguments produced by the first and second AI based models, to determine whether the cybersecurity alert should be approved or denied. Depending on the approach, supplementing the positive and/or negative arguments produced in method 300 may involve modifying details that are included in the positive and/or negative arguments. In some approaches, sub-operation 354 may involve adding to the positive and/or negative arguments based at least in part on the evaluation performed in sub-operation 352. In some approaches, sub-operation 354 involves removing details from to the positive and/or negative arguments based at least in part on the evaluation performed in sub-operation 352. For example, the evaluation may reveal that one or more arguments are duplicates, incorrect, contradicting each other, incomplete, etc., thereby indicating that at least some information should be removed. In still other approaches, sub-operation 354 involves rearranging details in the positive and/or negative arguments based at least in part on the evaluation performed in sub-operation 352.

From sub-operation 354, the flowchart proceeds to sub-operation 356. There, sub-operation 356 includes causing the third trained AI based model to produce the final assessment of the cybersecurity alert. The final assessment is preferably produced based at least in part on evaluating the most relevant subset of the positive and negative arguments. In other words, the third trained AI based model inspects the “closest match(es)” to the prompt and determines a final result to output. In some approaches, sub-operation 356 includes selecting a predetermined number (e.g., 2, 3, 4, 5, 6, 7, 8, 9, 10, 15, 20, 25, 30, 40, 50, 100, 1000, 5000, etc.) of the of the closest matches and combining the selected closest matches to form an average closest match. In other approaches, a single closest match may be identified and produced by the third AI based model, e.g., based at least in part on syntactic context, matching terms, past performance, real-time evaluation, etc. In still other approaches, the third AI based model may evaluate the most relevant subset of the positive and negative arguments and generate a new argument that summarizes relevant portions of information included therein.

It should be noted that although the sub-operations in FIG. 3B are described in the context of a trained AI based model evaluating the positive and negative arguments that are produced in method 300, this is in no way intended to be limiting. According to one example, which is in no way intended to be limiting, a security analyst (e.g., application, predetermined sequence of operations, human person, etc.) may be used to also evaluate the positive and negative arguments and/or a corresponding cybersecurity alert, e.g., as would be appreciated by one skilled in the art after reading the present description.

Referring momentarily now to FIG. 3C, exemplary sub-operations of evaluating the positive and negative arguments produced by the first and second AI based models (e.g., see operations 306, 308 respectively) to determine whether the prompt and corresponding cybersecurity alert should be approved or denied, are illustrated in accordance with another approach. It follows that one or more of the sub-operations in FIG. 3C may be used to perform operation 310 of FIG. 3A in response to receiving one or more instructions, in response to a predetermined condition being met, in response to a cybersecurity alert and/or corresponding prompt, etc.

As shown, sub-operation 372 includes presenting the positive and negative arguments to a human analyst, while sub-operation 374 includes receiving a most relevant subset of the positive and negative arguments from the human analyst. In other words, supplying the positive and negative arguments to one or more security analysts for analysis allows for supplemental insight to be received therefrom. Moreover, this directed insight from the security analyst(s)may further be combined with insights that are produced by the various trained AI based models herein. It should be noted that in some approaches, sub-operation 372 includes presenting the positive arguments to a first human analyst configured to evaluate the positive arguments and presenting the negative arguments to a second human analyst configured to evaluate the negative arguments; while sub-operation 374 includes receiving a most relevant subset of the positive arguments from the first human analyst as well as receiving a most relevant subset of the negative arguments from the second human analyst. In some approaches, sub-operation 374 includes receiving supplemental arguments from a human analyst. These supplemental arguments may be considered in combination with any of the received arguments, by any of the trained AI based models herein in making determinations.

Looking still to FIG. 3C, sub-operation 376 includes causing the third trained AI based model to produce the final assessment of the cybersecurity alert. In other words, the third trained AI based model preferably generates the final assessment of whether the cybersecurity alert is verified by combining at least some of the positive and/or negative arguments. For instance, in preferred approaches, the final assessment is based at least in part on evaluating the most relevant subset of the positive and negative arguments selected and received from the human analyst. In some approaches, the third trained AI based model produces the final assessment of the cybersecurity alert based at least in part on the most relevant subset of the positive and negative arguments, in addition to any of the additional positive and negative arguments that may be received directly from analyst(s).

It should be noted that while the sub-operations in FIG. 3B involve using two or more trained AI based models to evaluate the received cybersecurity alert and/or related prompt, and while the sub-operations in FIG. 3C involve using an AI based model along with a security analyst to evaluate the received cybersecurity alert and/or related prompt, this is in no way intended to be limiting. For example, in still other approaches, received cybersecurity alerts and/or related prompts may be repeatedly inserted into an AI based model that is trained to produce positive arguments, and repeatedly inserted into another AI based model that is trained to produce negative arguments. It follows that any desired number of positive and/or negative arguments may be generated by each AI based model for each cybersecurity alert and/or related prompt. Moreover, any desired number of positive and/or negative arguments may be generated by repeating the evaluation of the cybersecurity alert and/or related prompt any desired number of times.

Returning back now to FIG. 3A, method 300 advances from operation 310 to operation 312 in response to the third trained AI based model producing a final assessment of the cybersecurity alert. There, operation 312 includes determining whether the cybersecurity alert should be verified. In other words, operation 312 includes using any information received from the trained AI based models to characterize the cybersecurity alert originally received. As noted above, the third AI based model may use information gathered from evaluating the arguments to make a determination as to whether the prompt is true (indicating that the received cybersecurity alert is genuine and should be processed) or false (indicating that the received cybersecurity alert is questionable and should be ignored). Moreover, while any of the trained AI based models may include LLMs as described in the various approaches herein, any desired types of AI based models may be used.

In some approaches, operation 312 includes comparing (e.g., weighing) the outputs that are produced by each of the trained AI based models. For instance, any of the produced outputs may be compared against a predetermined range, industry standards, past performance metrics, user preferences, runtime limitations (e.g., available resources), etc. In response to the final assessment indicating that the cybersecurity alert is not authentic, method 300 advances from operation 312 to operation 314. There, operation 314 includes marking the cybersecurity alert as not-verified, before proceeding to operation 316 and rejecting the cybersecurity alert. It follows that approaches herein intentionally refrain from addressing (e.g., reacting) to cybersecurity alerts that are evaluated and determined as being unverified. This desirably protects the underlying system from being exposed to nefarious acts that target certain aspects thereof, while also ensuring that legitimate cybersecurity alerts are identified and processed accordingly, e.g., as will be described in further detail below. In some approaches, operation 316 includes sending an error message to the source of the initial cybersecurity alert, sending an alert to a system host, updating a lookup table, etc. In some approaches, the source of unverified cybersecurity alerts may be flagged as a questionable source, causing future alerts received from the questionable source to be reviewed in further detail than cybersecurity alerts received from other sources.

Returning now to operation 312, method 300 advances directly to operation 318 in response to the final assessment indicating that the cybersecurity alert is authentic. There, operation 318 includes marking the cybersecurity alert as verified. In some approaches, the cybersecurity alert is marked (e.g., indicated) as being verified in a lookup table, in metadata that is appended to the cybersecurity alert, in a flag that is returned to a source of the cybersecurity alert, etc. Moreover, method 300 advances from operation 318 to operation 320 where the verified cybersecurity alert is processed. In other words, cybersecurity alerts that are inspected and identified as valid (e.g., legitimate) may be permitted for further processing by a SOC (e.g., see SOC module 215 of FIG. 2).

In some approaches, the final conclusion of the security issue and how it can be remediated may further be used in operation 320 to create one or more security tickets which outline the security issue and options of how to remedy it. In other words, operation 320 may include generating security based operations that may be performed to remedy the validated security issue. The security based operations and/or security tickets may be formed by a SOC in some approaches. Again, because the cybersecurity alert has been inspected and identified as valid, the SOC may invest resources in evaluating the alert to determine how it should be addressed without potentially exposing the SOC and system itself to malicious attempts at gaining access thereto and/or information therefrom. This desirably maintains security of the system and allows for cybersecurity related issues to be addressed without unnecessarily consuming resources.

Again, it follows that approaches herein are desirably able to implement automation using AI based models that are able to provide enough transparency as a result of automatically evaluating received cybersecurity alerts and determining their relative authenticity. Approaches herein are thereby able to combine the expertise of security analysts and AI based models that have been trained to provide information that is relevant in making a determination.

As noted above, this may be achieved as a result of training and implementing various AI based models. For instance, two or more LLMs may be individually trained and deployed to generate positive and/or negative arguments. For example, a first LLM may be trained (e.g., configured) to analyze a received cybersecurity alert or related prompt and generate a list of positive arguments. Moreover, a second LLM may be trained (e.g., configured) to analyze a received cybersecurity alert or related prompt and generate a list of negative arguments.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to generate positive and/or negative arguments for a given cybersecurity alert, supplement existing positive and/or negative arguments, merge two or more different arguments to respond to a cybersecurity alert, etc. Initial training may include reward feedback that may, in some approaches, be implemented using a subject matter expert (SME) that generally understands cybersecurity based issues for a given system or in general. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with cybersecurity alerts and/or how they impact the underlying system, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received in response to previous responses to the alerts that are produced. Such an AI model ensures that past performance is used to retrain the model(s) and impact future outputs, where the scale of such analysis and determinations would not otherwise be feasible for a human to perform. This is because humans are not able to efficiently evaluate the impact that various cybersecurity alerts have on the performance of an underlying system, and would otherwise incorporate processing delays and errors in the process of attempting to do so. Accordingly, management of operations described herein is not able to be achieved by human manual actions.

In some approaches, the number of arguments that are to be considered (e.g., evaluated) by the AI based models herein may be case-specific. Moreover, arguments may be weighed differently depending on an initial prompt, past performance, patterns identified by the AI based models, etc. In some approaches, the generated lists of arguments are further presented to a human analyst for further evaluation. For example, the analyst may select the arguments considered to be most relevant to the cybersecurity alert from the positive and negative lists of potential solutions (e.g., answers) to the base cybersecurity alert. An additional LLM may further be presented with the shortlist of arguments that have been selected for further evaluation. Based on this list, the evaluating LLM preferably makes a final decision regarding the prompt and returns the final answer along with a justification as to why the final answer was selected. This judgement performed by the LLM may also be used for the creation of cybersecurity tickets that describe the security issue and how it can be remediated. It follows that the final assessment may be produced along with a corresponding cybersecurity ticket that outlines the steps associated with addressing the final assessment.

Again, because the cybersecurity alert has been inspected and identified as valid, the SOC may invest resources in evaluating the alert to determine how it should be addressed without potentially exposing the SOC and system itself to malicious attempts at gaining access thereto and/or information therefrom. This desirably maintains security of the system and allows for cybersecurity related issues to be addressed without unnecessarily consuming resources.

Cybersecurity alerts (e.g., within an organization's networks) may be generated for analysis. The primary goal of this analysis is to classify each alert as either a true positive or a false positive. True positives indicate a potential security risk that should be immediately addressed, while false positives do not warrant further investigation. This analysis is conducted using a combination of automated tools and human security analysts, e.g., as described herein. For example, a security analyst may step in and submit a determination in situations where automation is unable to classify an alert. Approaches herein thereby introduce novel ways of solving cybersecurity alert classification problems that conventional products have suffered from. The approaches herein solve these conventional issues at least in part by combining the benefits (e.g., computational power) of AI based models (e.g., LLMs) with the expertise of security analysts in a transparent and reproducible way. Thus, multiple instances of LLMs may be used to perform different tasks, e.g., as described herein. Depending on the LLM capabilities, the solution may deploy different LLMs, each LLM being configured (e.g., trained) to perform a specific task. However, in still other approaches a single AI based model (e.g., LLM) may be trained to perform each step of a cybersecurity alert verification, e.g., as would be appreciated by one skilled in the art after reading the present description.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method comprising:
receiving a cybersecurity alert;
generating first and second prompts associated with verifying the cybersecurity alert;
causing a first trained AI based model to generate positive arguments to the first prompt;
causing a second trained AI based model to generate negative arguments to the second prompt;
causing a third trained AI based model to produce a final assessment of the cybersecurity alert based at least in part on the positive and negative arguments; and
in response to the final assessment indicating that the cybersecurity alert is not authentic, rejecting the cybersecurity based alert.

2. The method of claim 1, further comprising:
in response to the final assessment indicating that the cybersecurity based alert is authentic:
marking the cybersecurity based alert as verified; and
causing the verified cybersecurity based alert to be processed.

3. The method of claim 1, wherein the cybersecurity alert is received at a security operations center (SOC).

4. The method of claim 1, wherein the final assessment includes an answer to whether the cybersecurity alert is verified and a justification outlining how the answer was produced.

5. The method of claim 1, wherein the first, second, and/or third trained AI based model(s) include large language models (LLMs).

6. The method of claim 1, further comprising:
causing the third trained AI based model to produce the final assessment based at least in part on the most relevant subset of the positive and negative arguments.

7. The method of claim 1, further comprising:
presenting the positive and negative arguments to a human analyst;
receiving a most relevant subset of the positive and negative arguments from the human analyst;
receiving additional positive and negative arguments from the human analyst; and
causing the third trained AI based model to produce the final assessment of the cybersecurity alert based at least in part on the most relevant subset of the positive and negative arguments, and the additional positive and negative arguments.

8. A computer program product comprising:
one or more computer-readable storage media; and
program instructions stored on the one or more storage media to perform operations comprising:
receiving a cybersecurity alert;
generating first and second prompts associated with verifying the cybersecurity alert;
causing a first trained AI based model to generate positive arguments to the first prompt;
causing a second trained AI based model to generate negative arguments to the second prompt;
causing a third trained AI based model to produce a final assessment of the cybersecurity alert based at least in part on the positive and negative arguments; and
in response to the final assessment indicating that the cybersecurity alert is not authentic, rejecting the cybersecurity alert.

9. The computer program product of claim 8, wherein the operations further comprise:
in response to the final assessment indicating that the cybersecurity alert is authentic:
marking the cybersecurity alert as verified; and
causing the verified cybersecurity alert to be processed.

10. The computer program product of claim 8, wherein the cybersecurity alert is received at a security operations center (SOC).

11. The computer program product of claim 8, wherein the final assessment includes an answer to whether the cybersecurity alert is verified and a justification outlining how the answer was produced.

12. The computer program product of claim 8, wherein the first, second, and/or third trained AI based model(s) include large language models (LLMs).

13. The computer program product of claim 8, wherein the operations further comprise:
causing the third trained AI based model to produce the final assessment based at least in part on the most relevant subset of the positive and negative arguments.

14. The computer program product of claim 8, wherein the operations further comprise:
presenting the positive and negative arguments to a human analyst;
receiving a most relevant subset of the positive and negative arguments from the human analyst;
receiving additional positive and negative arguments from the human analyst; and
causing the third trained AI based model to produce the final assessment of the cybersecurity alert based at least in part on the most relevant subset of the positive and negative arguments, and the additional positive and negative arguments.

15. A computer system comprising:
a processor set;
one or more computer-readable storage media; and
program instructions stored on the one or more storage media to cause the processor set to perform operations comprising:
receiving a cybersecurity alert;
generating first and second prompts associated with verifying the cybersecurity alert;
causing a first trained AI based model to generate positive arguments to the first prompt;
causing a second trained AI based model to generate negative arguments to the second prompt;
causing a third trained AI based model to produce a final assessment of the cybersecurity alert based at least in part on the positive and negative arguments; and
in response to the final assessment indicating that the cybersecurity alert is not authentic, rejecting the cybersecurity alert.

16. The computer system of claim 15, wherein the operations further comprise:
in response to the final assessment indicating that the cybersecurity based alert is authentic:
marking the cybersecurity based alert as verified; and
causing the verified cybersecurity based alert to be processed.

17. The computer system of claim 15, wherein the cybersecurity alert is received at a security operations center (SOC).

18. The computer system of claim 15, wherein the final assessment includes an answer to whether the cybersecurity alert is verified and a justification outlining how the answer was produced.

19. The computer system of claim 15, wherein the first, second, and/or third trained AI based model(s) include large language models (LLMs).

20. The computer system of claim 15, wherein the operations further comprise:
causing the third trained AI based model to produce the final assessment based at least in part on the most relevant subset of the positive and negative arguments.
